(19) United States
(12) Patent Application Publication
(10) Pub. No.: US 2007/0193454 A1
(43) Pub. Date: Aug. 23, 2007

(54) Method and Apparatus for Killing Insects on Fresh Produce

(75) Inventor: Richard S. Brown, Chualar, CA (US)

Correspondence Address: HAYNES BEFFEL & WOLFELD LLP, P O BOX 366, HALF MOON BAY, CA, 94019, US

(73) Assignee: Western Precooling Systems, Fremont, CA (US)

(21) Appl. No.: 11/674,875

(22) Filed: Feb. 14, 2007

Related U.S. Application Data
(60) Provisional application No. 60/774,383, filed on Feb. 17, 2006.

(51) Int. Cl. A23L 3/3445; A23L 3/3418

(52) U.S. Cl. 99/472; 426/419; 422/32; 422/33

(57) ABSTRACT

To kill insects on fresh produce, the fresh produce is placed into the interior of a vacuum chamber and a partial vacuum is drawn and maintained within the interior for a time interval adequate to kill the insects. In some examples the holding step is carried out with the absolute pressure maintained in a range of 4.57 to 5.0 mm Hg. In some examples a pathogen-killing sanitizing gas is injected into the vacuum chamber at the end of the time interval. In some examples the partial vacuum is continued to be drawn within the interior during the holding step while adding small quantities of an inert gas into the interior

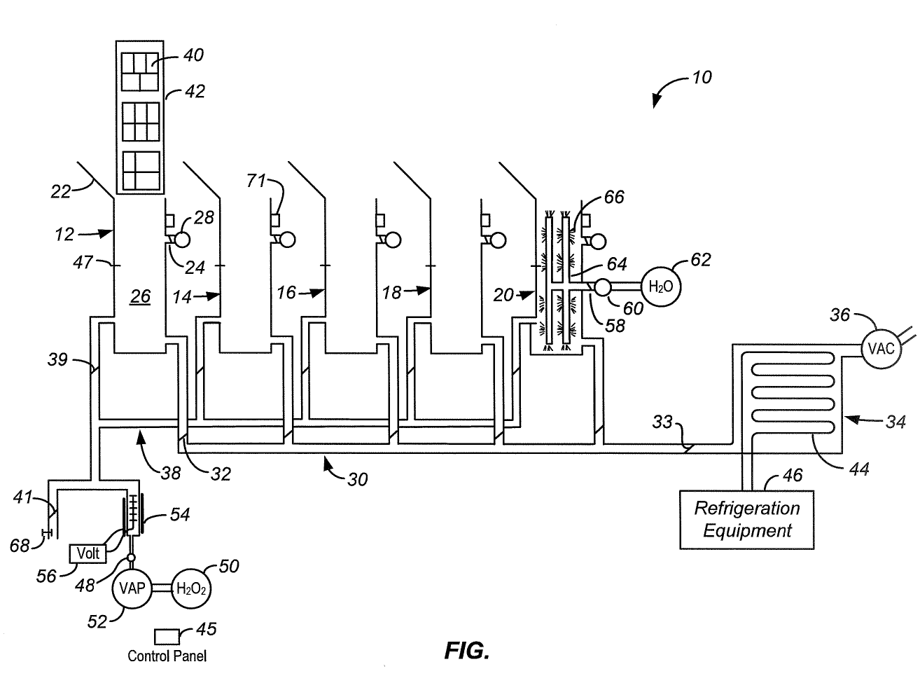

### CROSS-REFERENCE TO OTHER APPLICATIONS

This application claims the benefit of U.S. provisional patent application No. 60/774,383 filed 17 Feb. 2006 and entitled Killing Pathogens and Insects on Fresh Produce, the disclosure of which is incorporated by reference. This application is related to U.S. patent application Ser. No. 11/670,308, filed on 1 Feb. 2007 and entitled Method and Apparatus for Killing Pathogens on Fresh Produce, the disclosure of which is incorporated by reference.

### FEDERALLY SPONSORED RESEARCH OR DEVELOPMENT

None.

### BACKGROUND OF THE INVENTION

To meet phytosanitary standards for importing/exporting fresh produce to many countries, it is common to require either a) inspection which confirms the produce is free of live insects or b) the produce is fumigated with methyl bromide for a time and at a temperature necessary to kill live insects. Since a single live insect can cause a shipment to be rejected and destroyed, it is common practice for import/export produce to be fumigated as a preventive measure, regardless of whether or not live insects are evident during inspection.

### BRIEF SUMMARY OF THE INVENTION

A first example of a method for killing a target insect on fresh produce includes the following. Fresh produce is placed into the interior of a vacuum chamber, the fresh produce possibly carrying a live insect. A partial vacuum is drawn within the interior of the vacuum chamber. The produce is held inside said chamber, while maintaining the absolute pressure in a range of 4.57 to 25.0 mm Hg, for a time interval adequate to deplete any stored oxygen in the target insect and to kill the target insect by oxygen depravation. In some examples the holding step is carried out with the absolute pressure maintained in a range of 4.57 to 5.0 mm Hg. In some examples a pathogen-killing sanitizing gas is injected into the vacuum chamber at the end of the time interval.

A second example of a method for killing a target insect on fresh produce includes the following. Fresh produce is placed into the interior of a vacuum chamber, the fresh produce possibly carrying a live insect. A partial vacuum is drawn within the interior of the vacuum chamber. The produce is held inside the chamber for a time interval sufficient to kill the target insect. A partial vacuum is continued to be drawn within the interior of the vacuum chamber during the holding step while adding small quantities of an inert gas into the interior of the vacuum chamber to maintain the desired partial vacuum during said time interval.

An example of apparatus for killing insects on fresh produce comprises a series of vacuum chambers, each vacuum chamber having an interior and a produce entrance through which fresh produce can be introduced into the interior. The apparatus also comprises vacuum cooling assembly comprising a vacuum cooling apparatus and a vacuum cooling manifold fluidly connecting each of the vacuum chambers to the vacuum cooling apparatus. The vacuum cooling manifold includes a vacuum manifold valve associated with each vacuum chamber for selectively permitting and preventing fluid flow between the vacuum cooling apparatus and the associated vacuum chamber. The vacuum cooling assembly can therefore selectively create a partial vacuum within the interiors of selected ones of the vacuum chambers. The apparatus also includes secondary vacuum apparatus selectively fluidly connected to each said vacuum chamber to maintain for a time interval the partial vacuum within the interior of the associated vacuum chamber created by the vacuum cooling assembly. In some embodiments at least one of the vacuum chambers comprises a water application apparatus so that water can be applied to the fresh produce within said at least one vacuum chamber. Some embodiments may include means for introducing a sanitizing gas into a selected vacuum chamber after the time interval, the sanitizing gas comprising ionized hydrogen peroxide. In some embodiments the secondary venting apparatus comprises an inert gas injector adapted to inject an inert gas into the interior during the operation of the secondary venting apparatus.

Other features, aspects and advantages of the present invention can be seen on review of the figures, the detailed description, and the claims which follow.

### BRIEF DESCRIPTION OF THE DRAWING

The FIGURE is a schematic top plan view illustrating one embodiment of an insect killing apparatus made according to the present invention.

### DETAILED DESCRIPTION OF THE INVENTION

Several studies have been conducted to determine the efficacy of prolonged vacuum exposure to kill insects. This work has been conducted over many decades beginning with Back and Cotton in 1925. Results have been mixed. Significant to the studies has been the issue with the amount of vacuum drawn on the holding container and the time held at the reduced pressure. Most studies have included warm temperatures for increased insect metabolism and higher torr settings remaining well above the vapor pressure of water. Typical torr holding pressures for these experiments were in the 35 to 50 mm Hg range.

Methyl bromide is believed to damage stratospheric ozone and is classified as a Class I ozone-depleting substance. The amount of methyl bromide allowed for use in the US is being incrementally reduced in accordance with the Montreal Protocol on Substances that Deplete the Ozone Layer. Research is ongoing in many countries to find an effective alternative to methyl bromide, but results for many agricultural crops have been insufficient to date causing the Critical Use Exemptions for agricultural products to be extended on multiple occasions. While the present invention does not eliminate the use of methyl bromide in all applications, such as soil fumigation, it does provide a technically and economically feasible alternative for certain freshly harvested fruits and vegetables.

The present invention finds particular utility when carried out with fresh vegetables which generally do not suffer from chill induced injury. Therefore, in some examples the desired temperature is just above the freezing point for the fresh produce in question, such as 31.2° F. (±0.1° F.) in the case of iceberg lettuce.

Vacuum cooling is a method of chilling fresh vegetables such as iceberg lettuce by reducing the pressure inside a rigid chamber. Air is typically drawn from the chamber through a series of refrigeration coils by vacuum pumps. When the pressure inside the chamber lowers to the vapor pressure of water, water is released from the produce thereby releasing energy (latent heat of vaporization). The refrigeration coils collapse the steam back to liquid or frozen water so the vacuum pumps do not have to draw it from the chamber. The process continues until the produce has reached the desired temperature. A typical vacuum cooling cycle for a truckload quantity of iceberg lettuce is 25 minutes to 35 minutes in duration. Vacuum cooling has been practiced for decades and is described in the following exemplary patents: U.S. Pat. No. 4,576,014 to Miller; U.S. Pat. No. 3,008,838 to Brunsing; U.S. Pat. No. 5,922,169 to Later.

Some food borne illness events are traced back to insect contamination of fresh produce. This invention addresses a method of killing insects on fresh produce by subjecting the produce to a low oxygen environment for a sufficient time interval, such as 6-48 hours, the interval depending on the particular insect of concern. This is typically accomplished during the initial cooling step to reduce field heat. The time interval is selected to be adequate to deplete any stored oxygen in the insect to kill the insect by oxygen depravation. In some embodiments partial vacuum settings in the range of 4.6 mm Hg to 5.0 mm Hg will have the desired effect of maintaining a low O₂ environment injurious to insects while holding the produce in a refrigerated state.

The introduction of a sanitizing gas including, for example, hydrogen peroxide (H₂O₂) may be introduced into the vacuum chamber; this may occur as air is reintroduced into the vacuum chamber. In addition to H₂O₂, sanitizing gases including hydrogen peroxide and one or more other sanitizing agents, such as ozone, acidic acid and chlorine dioxide, may be introduced during the cooling process. However, for simplicity the invention will typically be discussed with reference to H₂O₂ as the sanitizing agent of the sanitizing gas. While in the present invention hydrogen peroxide is typically in the form of vaporized, ionized hydrogen peroxide, it, as well as other sanitizing agents, can be in mist, vapor, atomized or sprayed forms. Also, while ionization of the sanitizing agent, in particular hydrogen peroxide, is typically preferred because it increases the efficiency and speed for reducing pathogens which may also be present on the fresh produce, thus increasing the log reduction of pathogens, in some situations the sanitizing agent may not be in an ionized form.

The following description of the invention will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments are commonly referred to with like reference numerals.

The FIGURE discloses insect killing apparatus 10 including a series of vacuum chambers 12, 14, 16, 18 and 20, each vacuum chamber including a door 22. Each vacuum chamber 12-20 also includes a secondary vacuum valve 24 used to selectively connect the interior 26 of the associated vacuum chamber to a secondary vacuum pump 28; the purpose of vacuum pump 28 will be discussed below. A vacuum manifold 30, including a vacuum manifold valve 32 for each vacuum chamber, is used to selectively couple the vacuum chambers 12-20 along paths past a primary vacuum manifold valve 33 in the vacuum manifold, through a refrigeration coil chamber 34 and to a primary vacuum pump 36. Primary vacuum pump 36 is used to reduce the pressure within the interiors 26 of vacuum chambers 12-20, as will be discussed in more detail below. Vacuum chambers 12-20 are also connected to a return air manifold 38 to, for example, permit the controlled reintroduction of air, and optionally other gases, into each vacuum chamber as discussed below. Return air manifold 38 includes an individual return air valve 39 for each vacuum chamber 12-20 and a primary return air valve 41.

In use, fresh produce 40 is placed onto a shuttle 42 which is then moved into interior 26 of, in this example, vacuum chamber 12. An alternative is to place the fresh produce directly on the floor of the vacuum chamber. The chamber door 22 is closed forming an airtight seal. Vacuum manifold valves 32, secondary vacuum valves 24 and return air valves 39 are initially closed.

At the start of a vacuum cooling cycle (cooling cycle), vacuum manifold valve 32 for vacuum chamber 12 and primary vacuum manifold valve 33 are opened. Individual vacuum manifold valves 32 for vacuum chambers 14-20, primary return air valve 41, individual return air valves 39 and valves secondary vacuum valves 24 are closed. Primary vacuum pump 36 starts to draw air from the vacuum chamber 12. Refrigeration coils 44, contained within refrigeration coil chamber 34, are chilled by refrigeration equipment 46. These operations, as well as other operations, are typically controlled by and monitored at control panel 45 in a conventional, or in an unconventional, manner.

When the atmospheric pressure within the interior 26 of vacuum chamber 12 is equal to the vapor pressure of the liquid inside or on the surface of the fresh produce 40, as sensed by a pressure transducer 47 monitoring the pressure within the interior of the vacuum chamber, the fresh produce heat is removed through vaporization (latent heat of vaporization—change in state from a liquid to a vapor). The released water vapor drawn out of the chamber by the primary vacuum pump 36 first passes through the refrigeration coils 44 where it is condensed into water and/or ice to reduce the pumping load on the vacuum pumps. The cycle continues until the product is chilled to the desired temperature, usually just above the freezing point, that is typically about 33° F. more or less. Absolute pressure will, in some examples, have been lowered to approximately 4.6 mm Hg. In some examples the absolute pressure can range from 4.57 to 25.0 mm Hg, with a common range being 4.6 to 5.0 mm Hg.

Individual vacuum manifold valve 32 for chamber 12 is then closed. Secondary vacuum valve 24 for chamber 12 is opened and the secondary vacuum pump 28 for chamber 12 is energized to maintain the absolute pressure inside the vacuum chamber 12 at or near a desired set point; in some examples this desired set point is 4.6 mm Hg. The fresh produce 40 will be held at or near this set point for the duration of the hold time (hold cycle). In some examples the hold cycle can be as short as 6 hours or as long as 48 hour or more, depending on the insect, including its expected stage or stages, to be killed. Typical hold cycles are about 20-30 hours. The use of the same primary vacuum pump 36 to create the partial vacuum within the vacuum chambers coupled with the use of secondary vacuum pump 28 for each vacuum chamber to maintain the desired partial vacuum, eliminates the need for a much larger vacuum pump, such as primary vacuum pump 36, for each vacuum chamber.

During the hold time secondary valve 24 may be opened and closed while secondary vacuum pump 28 continues to operate so that the partial pressure inside the chamber 12 is maintained within the desired range. As an alternative, secondary vacuum pump 28 may be started and stopped as necessary to maintain the partial pressure inside the chamber 12 within the desired range. Another alternative is to allow secondary vacuum pump 28 to operate continuously while leaving secondary valve 24 open and to use an inert gas injector 71 to inject small quantities of an inert gas, such as nitrogen gas, into the chamber 12 as necessary to maintain the partial pressure inside the chamber 12 within the desired range. The use of inert gas injector 71 in conjunction with a secondary vacuum pump 28 prevents the need to continuously start and stop secondary vacuum pump 28 while eliminating the conventional practice of injecting oxygen-containing air into the chamber 12 during such continuous pumping. The elimination of the injection of oxygen-containing air into the chamber 12 is important to help continue to deprive insects on the fresh produce of oxygen.

According to the embodiment shown in the FIGURE, vacuum chambers 14-20 are filled with fresh produce while chamber 12 is in the vacuum cool cycle. Once chamber 12 is switched to the hold cycle and individual vacuum manifold valve 32 for chamber 12 is closed, the individual vacuum manifold valve 32 for chamber 14, for example, can be opened to begin the cool cycle in vacuum chamber 14. The cooling and hold cycles for chamber 14 proceed as for chamber 12. This process continues for chambers 16-20 as well.

Once vacuum chamber 12 has reached the desired hold cycle interval, such as 20 hours, the secondary vacuum pump 28 for chamber 12 is switched off, secondary vacuum valve 24 for chamber 12 is closed, and primary return air valve 41 is opened allowing fresh air into the return air manifold 38. Individual return air valve 39 for vacuum chamber 12 is opened allowing air to reenter vacuum chamber 12 and bring the atmospheric pressure back to ambient. Door 22 for vacuum chamber 12 is opened and shuttle 42 is moved out so that the fresh, vacuum treated produce may be removed and shipped to customers. After vacuum chamber 12 is empty it may be refilled with more fresh produce and the cool cycle and hold cycle can begin again.

An alternative re-pressurization method includes introducing an ionized stream of vaporized, atomized, or misted hydrogen peroxide solution into the vacuum chamber to reduce surface pathogens on the fresh produce. This is discussed in more detail in U.S. provisional patent application No. 60/774,383 filed 17 Feb. 2006 and entitled Killing Pathogens and Insects on Fresh Produce, the disclosure of which is incorporated by reference. Such process proceeds generally as follows. At the end of the vacuum cooling cycle, primary vacuum valve 33 is closed to prevent hydrogen peroxide from flowing into the refrigeration coils 44. Individual return air valve 39 is opened. A hydrogen peroxide control valve 48 allows H₂O₂ solution to flow from the storage tank 50 and to a hydrogen peroxide vaporizer 52. A plasma generator 54 is energized by a high voltage source 56. Vaporized H₂O₂ is then directed past the plasma generator 54 where it is ionized and then sucked through the return air manifold 38, into the vacuum chamber 12 and around the fresh produce 40 in the vacuum chamber. This process continues until the vacuum chamber 12 reaches a predetermined absolute pressure set point (for example, 350 mm Hg). At that point the vaporizer 52 is deactivated, the H₂O₂ control valve 48 is closed and the primary return air valve 41 is opened to allow the vacuum chamber 12 to continue re-pressurizing with fresh air until the vacuum chamber pressure equalizes with atmospheric pressure. Another method is to introduce an inert gas at the end of the cooling cycle (see U.S. Pat. Nos. 6,189,299, 6,379,731, 6,470,795). Another alternative is to combine an ionized stream of vaporized (or atomized or misted) hydrogen peroxide solution with an inert gas such as nitrogen.

Certain produce items such as celery may benefit from added surface moisture during the cooling cycle. Such a system may include a potable water source, water piping, water distribution nozzles and water pumps and water control valves. The general introduction of water is described as follows with reference to vacuum chamber 20.

Fresh produce is placed inside vacuum chamber 20. The cooling cycle is begun as previously described. Prior to the point when the partial pressure inside the vacuum chamber 20 reaches the vapor pressure of the fresh produce, a water delivery valve 58 is opened, a water pump 60 is activated and potable water from a water source 62 is pumped through the nozzles 66 of a water spray manifold 64 and down onto the fresh produce. The sprayed water then flows down the fresh produce thereby coating the surfaces of the produce. As the absolute pressure continues to fall, the surface water vaporizes, carrying away heat from the fresh produce. Additional sprays of potable water can be added during the cool cycle to aid the cooling of the produce. During the hold cycle brief sprays can be administered to prevent dehydration. The water may be re-circulated so as not to introduce additional heat inside the vacuum chamber. The water may be treated with a sanitizing agent to help lower surface pathogens in the water and on the surface of the fresh produce. Examples of sanitizers may include sodium hypochlorite, peracetic acid, or vinegar.

Certain fresh produce, such as romaine lettuce, can bruise if air is allowed to flow too quickly back in to the vacuum chamber during re-pressurization. Therefore a restriction valve 68 can be added to slow the flow of air re-entering the vacuum chamber. See U.S. Pat. No. 3,008,838 to Brunsing and U.S. Pat. No. 4,576,014 to Miller.

In some situations it may be desirable to induce motion to the fresh produce so as to expose more surface area to the sanitizing gas. This can be done in a number of ways, including at least one of the following: vibrating, oscillating, shaking, tumbling, rotating, turning and flipping.

### EXAMPLE

1. Place fresh produce (the product) which is not subject to chill injury inside a vacuum chamber.

2. Begin vacuum cooling the product by creating a partial vacuum within the vacuum chamber.

3. Continue to lower the vacuum to a chosen set point as necessary to ensure the product is at a desired temperature for the product (typically about 33° F. or 1° C.). Maintain absolute pressure in the range of, for example, 4.6 mm Hg to 5.0 mm Hg for a short time as necessary to ensure the field heat has been released.

4. Maintain the absolute pressure inside the vacuum chamber at or near a desired set point for the duration of the hold time (hold cycle), typically about 20-30 hours.

5. In some examples, at the end of the hold cycle, instead of reintroducing air (or nitrogen or a mix of gasses such as air and nitrogen) that occurs during conventional vacuum cooling procedures, the following steps can be performed:

a. Direct a stream of vaporized hydrogen peroxide (H₂O₂) through a corona to ionize the stream and create ionized vapor.

b. Mix this ionized vapor with the air (or a mix of gasses such as air and nitrogen) returning to the vacuum chamber.

c. Continue venting until the absolute pressure within the vacuum chamber has risen to, for example, approximately 300 mm Hg.

d. Stop the venting and pause for a period of time to allow the vapors to condense onto the surfaces of the fresh produce. It is also possible to continue applying the ionized vapors until the chamber reaches atmospheric pressure.

e. Close the H₂O₂ stream and continue venting the chamber to atmospheric pressure (approx 760 mm Hg) with air (or a mix of gasses such as air and nitrogen).

5. Remove the produce from the chamber.

6. Transport to market.

The percent concentration of the H₂O₂ solution (in water) to be vaporized can range from 3% or lower to as high as 70% or more. After the H₂O₂ gives up an Oxygen atom during the disinfection process the remainder is water (H₂O). This makes the choice of H₂O₂ as opposed to some other sanitizing gas or gasses quite desirable. The decision of which concentration is chosen may be determined at least in part by the desired amount of residual surface water on the produce surfaces. For example, iceberg lettuce might be best kept dry while asparagus may perform better with a light surface moisture coating. While this invention allows concentrations of H₂O₂ of 70% and higher, safety concerns suggest the highest likely solution will be below 50% concentration. H₂O₂ is usually buffered to prevent premature breakdown so it is important to use only buffering agents which are approved for food contact use.

The temperature of the fresh produce is typically maintained at around 32° F. However, depending upon the produce, the type of insect or insects and the life stage or stages for the insect or insects, the temperature of the fresh produce may also be maintained in the range of 32° F. to 55° F., or more preferably be maintained in the range of 32° F. to 39° F., during at least a portion of the hold cycle.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims.

Any and all patents, patent applications and printed publications referred to above are incorporated by reference.

What is claimed is:

1. A method for killing a target insect on fresh produce comprising:
placing fresh produce into the interior of a vacuum chamber, the fresh produce possibly carrying a live insect;
drawing a partial vacuum within the interior of the vacuum chamber; and
holding said produce inside said chamber, while maintaining the absolute pressure in a range of 4.57 to 25.0 mm Hg, for a time interval adequate to deplete any stored oxygen in the target insect and to kill the target insect by oxygen depravation.

2. The method according to claim 1 wherein the holding step is carried out with the absolute pressure maintained in a range of 4.57 to 5.0 mm Hg.

3. The method according to claim 1 further comprising maintaining the temperature of the fresh produce during at least a portion of the time interval in the range of 32° F. to 55° F.

4. The method according to claim 1 further comprising maintaining the temperature of the fresh produce during at least a portion of the time interval in the range of 32° F. to 39° F.

5. The method according to claim 1 further comprising selecting 6 to 48 hours as the time interval.

6. The method according to claim 1 further comprising selecting 20 to 30 hours as the time interval.

7. The method according to claim 1 further comprising continuing to draw a partial vacuum within the interior of the vacuum chamber during the holding step while adding small quantities of an inert gas into the interior of the vacuum chamber to maintain the desired partial vacuum during said time interval.

8. The method according to claim 1 further comprising introducing ambient air into the chamber at the end of the time interval.

9. The method according to claim 1 further comprising introducing one or more inert gasses into the vacuum chamber at the end of the time interval.

10. The method according to claim 1 further comprising introducing a mixture of air and one or more inert gasses into the vacuum chamber at the end of the time interval.

11. The method according to claim 1 further comprising introducing vaporized hydrogen peroxide into the vacuum chamber at the end of the time interval.

12. The method according to claim 1 further comprising introducing vaporized, ionized hydrogen peroxide into the vacuum chamber at the end of the time interval.

13. The method according to claim 1 further comprising introducing atomized hydrogen peroxide into the vacuum chamber at the end of the time interval.

14. The method according to claim 1 further comprising introducing a sanitizing gas comprising ionized, vaporized hydrogen peroxide into the vacuum chamber at the end of the time interval.

15. The method according to claim 1 further comprising introducing a pathogen-killing sanitizing gas into the vacuum chamber at the end of the time interval.

16. The method according to claim 15 further comprising the step of inducing motion to the fresh produce so as to expose more surface area to the sanitizing gas.

17. The method according to claim 16 wherein the motion inducing step comprises at least one of the following:
vibrating;
oscillating;
shaking;
tumbling;
rotating;
turning; and
flipping.

18. A method for killing a target insect on fresh produce comprising:
placing fresh produce into the interior of a vacuum chamber, the fresh produce possibly carrying a live insect;
drawing a partial vacuum within the interior of the vacuum chamber;
holding said produce inside said chamber for a time interval sufficient to kill the target insect; and
continuing to draw a partial vacuum within the interior of the vacuum chamber during the holding step while adding small quantities of an inert gas into the interior of the vacuum chamber to maintain the desired partial vacuum during said time interval.

19. The method according to claim 18 wherein the continuing step is carried out using nitrogen as the inert gas.

20. The method according to claim 18 wherein the holding step is carried out with the absolute pressure maintained in a range of 4.57 to 5.0 mm Hg.

21. The method according to claim 18 further comprising maintaining the temperature of the fresh produce during at least a portion of the time interval in the range of 32° F. to 39° F.

22. The method according to claim 18 further comprising introducing a pathogen-killing sanitizing gas into the vacuum chamber at the end of the time interval.

23. Apparatus for killing insects on fresh produce comprising:
a series of vacuum chambers, each vacuum chamber having an interior and a produce entrance through which fresh produce can be introduced into the interior;
a vacuum cooling assembly comprising:
a vacuum cooling apparatus;
a vacuum cooling manifold fluidly connecting each of the vacuum chambers to the vacuum cooling apparatus; and
the vacuum cooling manifold comprising a vacuum manifold valve associated with each vacuum chamber for selectively permitting and preventing fluid flow between the vacuum cooling apparatus and the associated vacuum chamber, whereby the vacuum cooling assembly can selectively create a partial vacuum within the interiors of selected ones of the vacuum chambers; and
a secondary vacuum apparatus selectively fluidly connected to each said vacuum chamber to maintain for a time interval the partial vacuum within the interior of the associated vacuum chamber created by the vacuum cooling assembly.

24. The apparatus according to claim 23 wherein the vacuum cooling apparatus comprises refrigeration coils for condensing water vapor.

25. The apparatus according to claim 24 wherein at least one of the vacuum chambers comprises a water application apparatus so that water can be applied to the fresh produce within said at least one vacuum chamber.

26. The apparatus according to claim 23 further comprising means for introducing a sanitizing gas into a selected vacuum chamber after the time interval, the sanitizing gas comprising ionized hydrogen peroxide.

27. The apparatus according to claim 23 wherein the secondary venting apparatus comprises an inert gas injector adapted to inject an inert gas into the interior during the operation of the secondary venting apparatus.
